(19) United States
(12) Patent Application Publication
(10) Pub. No.: US 2025/0369567 A1
(43) Pub. Date: Dec. 4, 2025

(54) OIL DISTRIBUTOR AND REDUCER

(71) Applicant: YANTAI JEREH OILFIELD SERVICES GROUP CO., LTD., Yantai (CN)

(72) Inventors: Junlei YAO, Yantai (CN); Mengran WANG, Yantai (CN); Cheng LI, Yantai (CN); Xueqing GAO, Yantai (CN); Maoqin LI, Yantai (CN)

(73) Assignee: YANTAI JEREH OILFIELD SERVICES GROUP CO., LTD., Yantai (CN)

(21) Appl. No.: 19/229,608

(22) Filed: Jun. 5, 2025

Related U.S. Application Data
(63) Continuation of application No. PCT/CN2024/133732, filed on Nov. 22, 2024.

(30) Foreign Application Priority Data
May 28, 2024 (CN) 202421187892.6

(51) Int. Cl. F16N 25/00; F16H 57/04

(52) U.S. Cl. CPC F16N 25/00; F16H 57/0421

(57) ABSTRACT

An oil distributor includes a top surface and a bottom surface opposite to each other, and a side surface located between the top surface and the bottom surface. The top surface, the bottom surface, and the side surface form an oil distribution chamber. The top surface is provided with an oil inlet hole, which is communicated with an oil inlet pipeline in an external oil passage. The side surface is provided with at least one oil outlet, which is communicated with a lubrication pipeline. The bottom surface is disposed at a through hole of a housing of the reducer, and the bottom surface is provided with an oil distribution pipe located inside the housing of the reducer. The oil distribution pipe is provided with at least one oil spraying hole, and the oil spraying hole is communicated with an interior of the housing of the reducer.

### CROSS-REFERENCE TO RELATED APPLICATIONS

This application is a continuation of and claims the benefit of priority to PCT Application No. PCT/CN2024/133732, filed Nov. 22, 2024, which is based on and claims the benefit of priority to Chinese Patent Application No. 202421187892.6 filed on May 28, 2024 with the China National Intellectual Property Administration. The above applications are incorporated herein by reference in their entireties.

### TECHNICAL FIELD

The present disclosure relates to an oil distributor and a reducer and relates to the technical field of manufacturing a reducer lubrication apparatus.

### BACKGROUND

A reducer is a transmission system of a fracturing device. A function of the reducer is converting power outputted by an engine through different speed ratio change design of internal gears of the reducer, so as to achieve the effects of speed reduction and torque increase as well as speed increase and torque reduction, to provide different transmission capabilities for the fracturing device.

During high-speed rotation of the reducer, gears and bearings in the narrow space of the reducer generate a lot of heat. If the heat is not taken away in time, internal transmission parts in the reducer may have pitting corrosion, gluing, and other problems due to an excessively high temperature, resulting in reduction of the service life and even direct scraping of the reducer. A lubrication system needs to ensure that lubricating oil is conveyed to surfaces of friction pairs such as the gears and the bearings in time, to protect friction parts from dry friction and take heat away. Therefore, the design of the lubrication system is quite important for continuous operation of the reducer.

Lubrication methods of the reducer include splashing (oil immersion) lubrication and forced lubrication. For a high-speed reducer, a forced lubrication method is usually used, by which a particular oil pressure is set up through an oil pump to lead oil to the surfaces of the friction pairs. The amount of oil can be determined according to the amount of heat that needs to be taken away. However, for the forced lubrication, oil passages need to be designed to lead oil, the lubrication system is relatively complex, and the maintenance is relatively difficult.

An existing reducer lubrication system is mainly composed of a lubricating oil passage, a joint, an oil inlet structure, and oil distribution design parts. Due to the fact that lubrication points (regions to be lubricated) are scattered and are partially located inside the reducer, in a current existing lubricating oil passage, usually a form of welding pipelines inside the reducer is used, to connect external pipelines with pipelines welded inside the housing, to lead the lubricating oil to the lubrication points. Although the design is simple, with continuous impact of vibrations generated or borne by the reducer during operation, the welding structures are extremely prone to fracture, especially, in key parts such as a lubrication structure at a meshed portion of bull gears and pinions. If the lubrication welding structure here is broken, the broken part is prone to falling into the gears, resulting in damage to meshed tooth surfaces, affecting the transmission, and even directly scrapping the gears in severe cases. Even if the broken part does not fall into the gears, the oil distribution function of the lubrication structure here is invalid, which affects the lubrication effect and reduces the service life of the gears. The lubrication welding structure has a high risk and a short service life, and the maintenance by a particular amount of human and material resources is required in the later stage, which increases the costs.

### SUMMARY

The technical problem to be solved by the present disclosure is to provide an oil distributor having both an oil outlet and an oil distribution pipe and a reducer including the oil distributor in view of the shortcomings of the prior art, so that the oil distributor can not only convey lubricating oil to different lubrication pipelines to provide the lubricating oil to a plurality of lubrication points, but also directly spray the lubricating oil to the lubrication points inside the reducer, to reduce the number of oil conveying pipelines inside the reducer and avoid the damage caused by a broken part to the gears when a welding portion of the oil conveying pipelines is broken. Therefore, the lubrication effect is good and the service life is long. In addition, the design of an oil distribution block such as an oil distribution ring or an oil distribution plate increases the flexibility of a built-in oil passage, and spraying positions of the lubricating oil can be controlled more accurately.

The technical problem to be solved by the present disclosure is implemented by the following technical solution:

The present disclosure provides an oil distributor, the oil distributor including a top surface and a bottom surface opposite to each other, and a side surface located between the top surface and the bottom surface, the top surface, the bottom surface, and the side surface being enclosed to form an oil distribution chamber, where
the top surface is provided with an oil inlet hole, and the oil inlet hole is communicated with an oil inlet pipeline in an external oil passage;
the side surface is provided with at least one oil outlet, and the oil outlet is communicated with a lubrication pipeline; and
the bottom surface is disposed at a through hole in a housing of the reducer, the bottom surface is provided with an oil distribution pipe located inside the housing of the reducer, the oil distribution pipe is provided with at least one oil spraying hole, and the oil spraying hole is communicated with an interior of the housing of the reducer and is configured to convey lubricating oil to a region to be lubricated in the housing.

To facilitate installation, limiting, and fixing of the oil distribution pipe, an end of the oil distribution pipe approaching the bottom surface is provided with a limiting structure.

To ensure establishment of a lubrication pressure, an end of the oil distribution pipe away from the bottom surface is closed.

To be able to convey the lubricating oil to more lubrication points, the part of the lubrication pipeline is communicated with the built-in oil passage.

To prevent oil leakage, a sealing structure is provided between the oil distributor and the housing.

The present disclosure provides a reducer, a housing of the reducer is provided with the above-mentioned oil distributor.

To better utilize the gravity and the pressure of the oil pump, the through hole in the housing of the reducer is provided above a side surface of a meshed portion of a gear pair in the reducer, and the oil distribution pipe is arranged above the meshed portion of the gear pair.

Preferably, an oil spraying range of the oil spraying hole is between a connection line between a center of the oil distribution pipe and a center of a bull gear of the gear pair and a connection line between the center of the oil distribution pipe and a center of a pinion of the gear pair.

To increase the flexibility of the built-in oil passage, one end of the built-in oil passage of the reducer is communicated with the lubrication pipeline, and the other end thereof is provided with an oil distribution block.

Preferably, the oil distribution block is an oil distribution plate, the oil distribution plate is T-shaped, an oil distribution plate oil distribution channel is disposed inside the oil distribution plate, one end of the oil distribution plate oil distribution channel is an oil distribution plate oil inlet communicated with the built-in oil passage, and the other end thereof is at least one oil distribution plate oil spraying port led to a region to be lubricated.

Preferably, the oil distribution block is annular and includes an oil inlet ring belt, a plurality of oil distribution ring oil distribution channels, and a plurality of oil distribution ring oil spraying ports successively arranged along a lubricating oil conveying direction.

In summary, the present disclosure provides an oil distributor having both an oil outlet and an oil distribution pipe and a reducer including the oil distributor, so that the oil distributor can not only convey lubricating oil to different lubrication pipelines to provide the lubricating oil to a plurality of lubrication points, but also directly spray the lubricating oil to the lubrication points inside the reducer, to reduce the number of oil conveying pipelines inside the reducer and avoid the damage caused by a broken part to the gears when a welding portion of the oil conveying pipelines is broken. Therefore, the lubrication effect is good and the service life is long. In addition, the design of an oil distribution block such as an oil distribution ring or an oil distribution plate increases the flexibility of a built-in oil passage, and spraying positions of the lubricating oil can be controlled more accurately.

The technical solutions of the present disclosure will be described in detail below with reference to the accompanying drawings and specific embodiments.

### BRIEF DESCRIPTION OF THE DRAWINGS

FIG. 1 is an example schematic three-dimensional diagram of a reducer provided with an oil distributor of the present disclosure;

FIG. 2 is an example partially enlarged view of FIG. 1;

FIG. 3 is an example schematic three-dimensional diagram of an oil distributor of the present disclosure;

FIG. 4 is an example cross-sectional view of an oil distributor of the present disclosure;

FIG. 5 is an example bottom view of an oil distributor of the present disclosure;

FIG. 6 is an example schematic three-dimensional diagram of another oil distributor of the present disclosure that does not include the part of an oil distribution pipe;

FIG. 7 is an example cross-sectional view of another oil distributor of the present disclosure that does not include the part of an oil distribution pipe;

FIG. 8 is an example schematic three-dimensional schematic diagram of an oil distribution pipe of an oil distributor of the present disclosure;

FIG. 9 is an example first schematic diagram of relative positions of an oil distributor and a gear pair of the present disclosure;

FIG. 10 is an example second schematic diagram of relative positions of an oil distributor and a gear pair of the present disclosure;

FIG. 11 is an example front view of an oil distribution plate of the present disclosure;

FIG. 12 is an example cross-sectional view along a line A-A of FIG. 11;

FIG. 13 is an example schematic diagram of an installation position of an oil distribution plate of the present disclosure;

FIG. 14 is an example front view of an oil distribution ring of the present disclosure;

FIG. 15 is an example cross-sectional view along a line B-B of FIG. 14; and

FIG. 16 is an example partially enlarged view of FIG. 15.

### DESCRIPTION OF REFERENCE NUMERALS

10a, 10b, 10b′, 10c, 10d, 10e, 10f, 10g, 10h, 10i, 10j heat dissipation patch
11a, 11c, 11d, 11j outer surface
12a, 12b′, 12c, 12d, 12e, 12f, 12g, 12h, 12i, 12j heat dissipation layer

### DETAILED DESCRIPTION

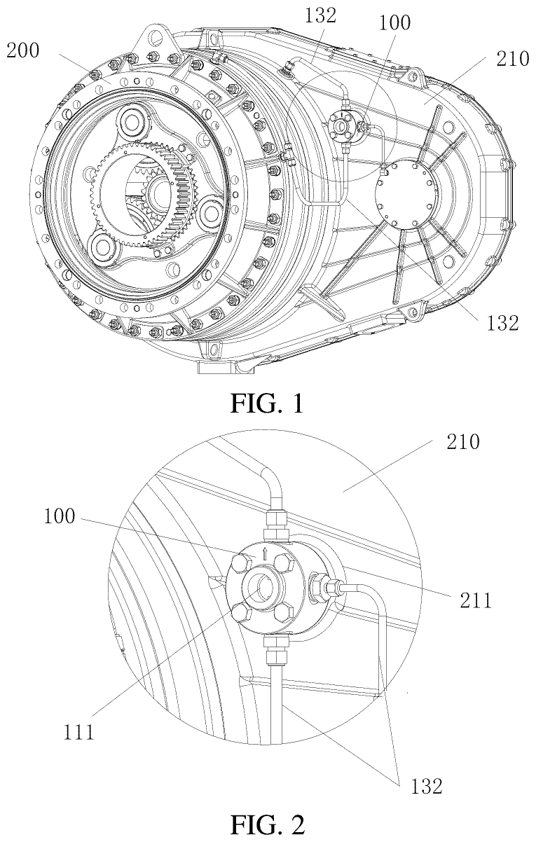

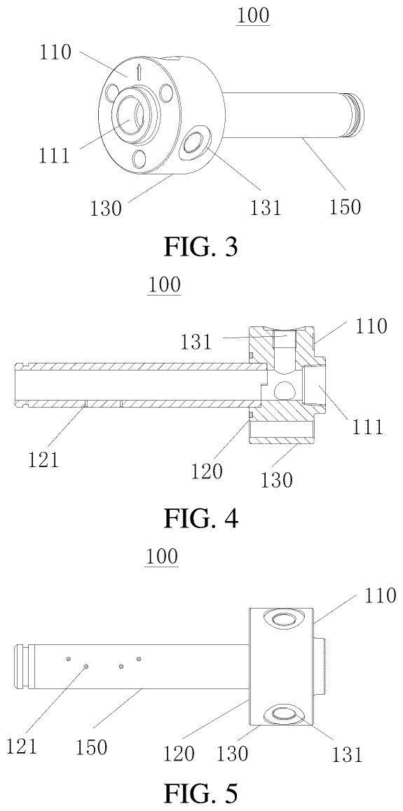

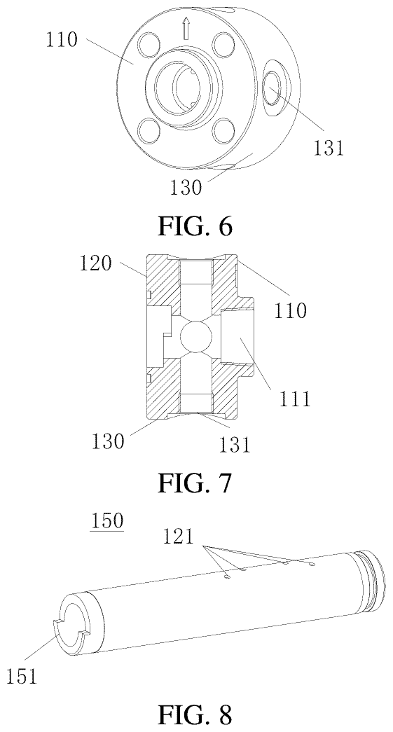

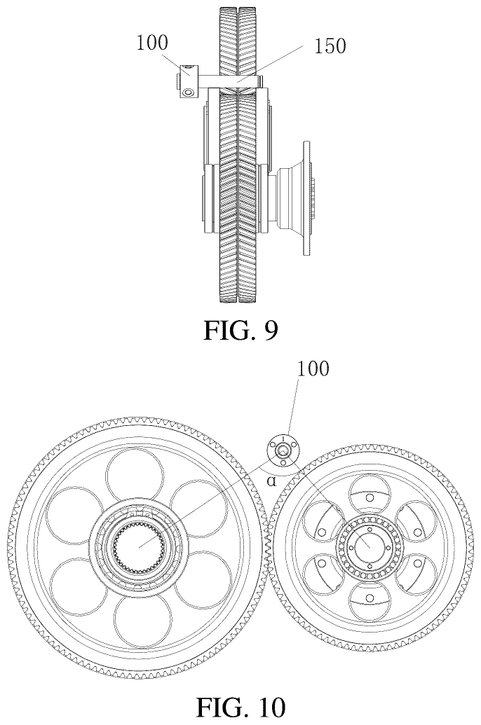

FIG. 1 is an example three-dimensional diagram of a reducer provided with an oil distributor of the present disclosure; FIG. 2 is an example partially enlarged view of FIG. 1; FIG. 3 is an example schematic three-dimensional diagram of an oil distributor of the present disclosure; FIG. 4 is an example cross-sectional view of an oil distributor of the present disclosure; FIG. 5 is an example bottom view of an oil distributor of the present disclosure; FIG. 6 is an example schematic three-dimensional diagram of another oil distributor of the present disclosure that does not include the part of an oil distribution pipe; FIG. 7 is an example cross-sectional view of another oil distributor of the present disclosure that does not include the part of an oil distribution pipe; FIG. 8 is an example schematic three-dimensional schematic diagram of an oil distribution pipe of an oil distributor of the present disclosure; FIG. 9 is an example first schematic diagram of relative positions of an oil distributor and a gear pair of the present disclosure; FIG. 10 is an example second schematic diagram of relative positions of an oil distributor and a gear pair of the present disclosure. As shown in FIG. 1 to FIG. 10, the present disclosure provides an oil distributor 100 and a reducer 200. The oil distributor 100 is disposed on the housing 210 of the reducer 200, is configured to distribute lubricating oil, and has a hollow structure. The reducer may be a parallel reducer, a planetary reducer, a combination thereof, or the like. In the present disclosure is described by an example in which the reducer is a parallel reducer.

The oil distributor 100 includes a top surface 110 and a bottom surface 120 opposite to each other, and a side surface 130 located between the top surface 110 and the bottom surface 120. The shape of the oil distributor 100 is not limited in the present disclosure, and may (substantially) be a cylinder, or may (substantially) be a cuboid or other shapes. The top surface 110, the bottom surface 120, and the side surface 130 are enclosed to form an oil distribution chamber.

It should be noted that, the top surface 110 and the bottom surface 120 may be flat surfaces, or may be stepped surfaces having a raised part or a recess, or may be arc surfaces, or the like, which can be designed and selected by those skilled in the art according to actual conditions. The top surface 110 is a side of the oil distributor 100 away from the reducer 200, and the bottom surface 120 is a side of the oil distributor 100 approaching the reducer 200.

The top surface 110 is provided with an oil inlet hole 111. The oil inlet hole 111 is communicated with an oil inlet pipeline in an external oil passage. For example, lubricating oil in an oil tank is pumped into the oil inlet pipeline in the external oil passage by a motor or an oil pump, and then enters an oil distribution chamber of the oil distributor 100 through the oil inlet hole 111. To ensure the quality of the lubricating oil and prevent pollutants in an external environment of the reducer body from entering the reducer, a filter may further be provided between the external oil passage and the motor or the oil pump.

Various connections in the present disclosure, such as a connection between the oil inlet pipeline and the oil inlet hole 111, can adopt an NPT thread connection (when a relatively large number of flexible connections exist) and a G thread connection (when a relatively large number of rigid connections exist), so as to facilitate replacement and switching.

The side surface 130 is provided with at least one oil outlet 131. The number of the oil outlets 131 is not limited in the present disclosure. In the example shown in FIG. 3 to FIG. 5, three oil outlets 131 are provided, and the three oil outlets 131 are evenly distributed on an outer periphery of the side surface 130. In the example shown in FIG. 6 to FIG. 7, four oil outlets 131 are provided, and the four oil outlets 131 are evenly distributed on an outer periphery of the side surface 130.

The oil outlet 131 is communicated with the lubrication pipeline 132, and the lubricating oil in the oil distribution chamber enters the lubrication pipeline 132 through the oil outlet 131 and is then conveyed to a region to be lubricated. The region to be lubricated is, for example, surfaces of a friction pair, such as gears or bearings. In this embodiment, for example, the region to be lubricated is a gear pair. The gear pair includes, for example, a bull gear and a pinion meshed with each other, and a diameter of the bull gear is greater than a diameter of the pinion.

The lubricating oil in the oil distribution chamber may alternatively enter the lubrication pipeline 132 through the oil outlet 131 and then be conveyed to a built-in oil passage, so as to be conveyed to other positions along the built-in oil passage. The built-in oil passage may be an oil passage provided in the housing 210 of the reducer 200.

The bottom surface 120 is provided at a through hole 211 in the housing 210 of the reducer 200. A connection mode between the oil distributor 100 and the housing 210 includes, but is not limited to, a bolt connection, a snap connection, or the like. The bottom surface 120 is provided with an oil distribution pipe 150 located inside the housing 210 of the reducer 200, the oil distribution pipe 150 is provided with at least one oil spraying hole 121, and the oil spraying hole 121 is communicated with an interior of the housing 210 of the reducer 200 to convey lubricating oil to the region to be lubricated in the housing 210. That is, the oil spraying hole 121 of the oil distribution pipe 150 directly supplies lubricating oil to the region to be lubricated in the housing 210, without connecting other structures such as another oil conveying pipeline. In other words, in this embodiment, the oil distributor 100 passes through the housing 210 of the reducer 200 through the through hole 211, the oil distribution pipe 150 is located inside the housing 210, and the part of the oil distributor 100 not including the oil distribution pipe 150 is located outside the housing 210. For example, a central axis of the part of the oil distributor 100 not including the oil distribution pipe 150 coincides with a central axis of the oil distribution pipe 150.

To facilitate installation, limiting, and fixing of the oil distribution pipe 150, the end of the oil distribution pipe 150 approaching the bottom surface 120 is provided with a limiting structure 151. In this example, the limiting structure 151 is a semicircular raised part. In addition, the oil distributor 100 is provided with a semicircular recess corresponding to the semicircular raised part. When the oil distribution pipe 150 is installed and fixed, the semicircular raised part and the semicircular recess are snap fitted with each other, so that the position of the oil distribution pipe 150 and the direction of the oil spraying hole 121 are restricted. The specific type of the limiting structure 151 is not limited in the present disclosure. For example, a structure such as a positioning pin and a positioning slot may alternatively be used.

To ensure establishment of a lubrication pressure, an end of the oil distribution pipe 150 away from the bottom surface 120 is closed. The closing may be implemented by the housing 210. For example, the housing 210 is pressed against the end of the oil distribution pipe 150 away from the bottom surface 120 through a sealing ring such as an O-ring or a D-ring, or may be implemented by directly using a round pipe with one end closed and one end open.

The present disclosure is not limited thereto, and the end of the oil distribution pipe 150 away from the bottom surface 120 may alternatively not be closed. For example, the end of the oil distribution pipe 150 away from the bottom surface 120 is communicated with another lubricating oil passage (for example, an opening on the housing, a built-in oil passage, or a lubrication pipeline), so as to provide lubricating oil to other regions to be lubricated.

The number and positions of the oil spraying holes 121 are not limited in the present disclosure. When a plurality of oil spraying holes 121 are provided, the oil spraying holes 121 may be arranged in a linear shape, an annular shape, an arc shape, a square shape, or the like. According to requirements, oil spraying directions of the plurality of oil spraying holes 121 may be the same or different.

To improve the lubrication effect, a projection of the oil spraying hole 121 in a vertical direction falls on the gear pair, or a distance between oil spraying hole 121 and an edge of the gear pair is less than 15 mm (in this case, the projection of the oil spraying hole 121 in the vertical direction is not on the gear pair, and is located outside the gear pair).

To implement sealing between the oil distributor 100 and the housing 210 of the reducer 200, a sealing structure is provided between the oil distributor 100 and the housing 210, and the sealing structure includes, but is not limited to, a sealing ring or a sealant. The dimension of the through hole 211 is arranged corresponding to the oil distributor 100, so that the oil distributor 100 and the housing 210 can be connected in a sealed manner, while the oil distribution pipe 150 can be located in the housing 210. Therefore, the lubricating oil can directly enter the housing 210 of the reducer 200 from the oil distribution chamber of the oil distributor 100 through the oil spraying hole 121 of the oil distribution pipe 150, to provide the lubricating oil to the region to be lubricated.

For example, as shown in FIG. 9 and FIG. 10, when the gear pair in the reducer 200 needs to be lubricated, the oil distribution pipe 150 is arranged above a meshed portion of the gear pair. In this case, the through hole 211 is provided above the side surface of the meshed portion of the gear pair.

To distribute the lubricating oil more accurately, in FIG. 10, an oil spraying range of the oil spraying hole 121 is between a connection line between a center of the oil distribution pipe 150 and a center of a bull gear and a connection line between the center of the oil distribution pipe 150 and a center of a pinion. The oil spraying range α<140°.

To accurately install the oil distributor 100, the oil distributor 100 is further provided with an error prevention structure, and the error prevention structure includes, but is not limited to, an arrow mark (as shown in FIG. 3) provided on the top surface 110, a limit slot provided on the oil distributor 100, and the like.

With the above-mentioned arrangement, the lubricating oil can flow through a plurality of positions to be lubricated in the reducer.

It needs to be further noted that, to simplify the oil passage design, for a part having a relatively large number of lubrication points and a narrow space in the reducer 200, a built-in oil passage can be processed by using locally thickened portions of a radial rib plate in combination with casting and molding convenience, or by adding a corresponding rib plate structure according to a requirement of a built-in oil passage. Usually, a built-in oil passage is processed by using a nearby rib plate. The use of the built-in oil passage can reduce the number of deployed pipelines and avoid welding of pipelines. It needs to be further noted that, a length-to-diameter ratio of the built-in oil passage is required to be not excessively large, or otherwise deviation of the oil hole may be caused, or a drill bit having a high rigidity is needed, which increases the processing cost. Therefore, the length-to-diameter ratio generally is required to not exceed 20.

However, due to the fact that an internal structure of the reducer 200 is relatively complex, a conventional built-in oil passage usually cannot convey lubricating oil to all regions to be lubricated, such as a plurality of spiral planetary gears and bearings. The present disclosure further provides an oil distribution block. An oil distribution channel is disposed in the oil distribution block. One end of the oil distribution channel is an oil inlet communicated with the built-in oil passage, and the other end of the oil distribution channel is at least one oil spraying port led to a region to be lubricated. That is, one end of the built-in oil passage is communicated with the lubrication pipeline 132, and the other end thereof is communicated with the oil inlet of the oil distribution block, so that the lubricating oil in the oil distribution chamber of the oil distributor 100 can enter the lubrication pipeline 132 through the oil outlet 131, then be conveyed to the built-in oil passage, and then be conveyed to the oil inlet of the oil distribution block along the built-in oil passage. Therefore, the oil is more accurately conveyed to a region to be lubricated.

The specific fixing and sealing methods of the oil distribution block are not limited in the present disclosure, and bolt fixing, sealant application, welding, interference insertion, O-rings, or the like can be used.

The specific structure of the oil distribution block is not limited in the present disclosure, and can be designed by those skilled in the art according to needs. For example, the following describes two types of oil distribution blocks.

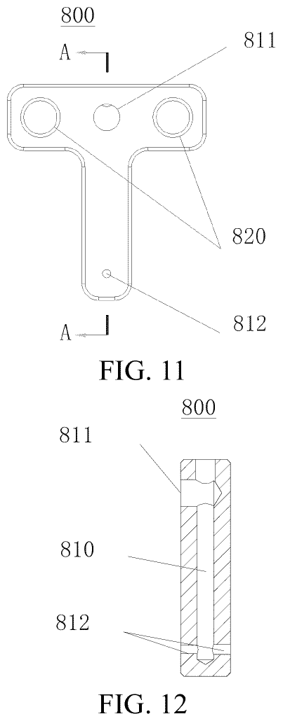

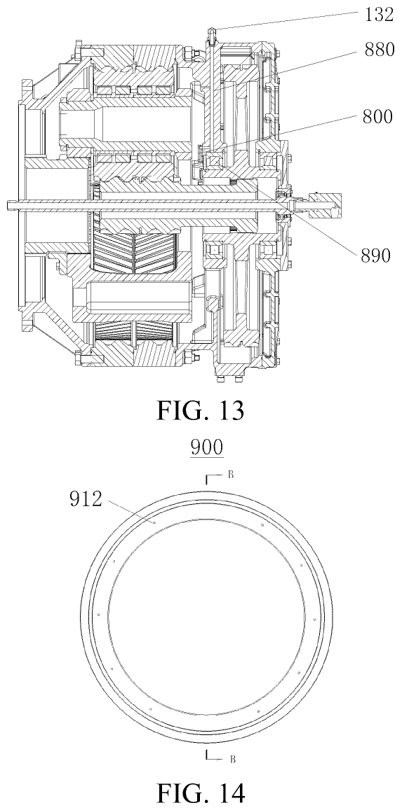

FIG. 11 is a front view of an oil distribution plate of the present disclosure; FIG. 12 is a cross-sectional view along a line A-A of FIG. 11; FIG. 13 is a schematic diagram of an installation position of an oil distribution plate of the present disclosure. As shown in FIG. 11 to FIG. 13, the oil distribution block is, for example, an oil distribution plate 800. The oil distribution plate 800 is (substantially) T-shaped. An oil distribution plate oil distribution channel 810 is disposed inside the oil distribution plate 800. One end of the oil distribution plate oil distribution channel 810 is an oil distribution plate oil inlet 811 communicated with a built-in oil passage (for example, the built-in oil passage 880 shown in the figures), and the other end thereof is at least one oil distribution plate oil spraying port 812 led to a region to be lubricated. For example, the oil distribution plate 800 may be arranged on one side of a bearing (for example, a rear bearing 890 of a bull gear), and provides lubricating oil to the bearing through the oil distribution plate oil spraying port 812.

To fix the oil distribution plate 800, the oil distribution plate is further provided with a fixing hole 820, and the oil distribution plate 800 can be fixed on the housing 210 of the reducer 200 through the fixing hole 820 by a bolt or the like. Preferably, two fixing holes 820 are provided, and the two fixing holes 820 are provided on two sides of the oil distribution plate oil distribution channel 810.

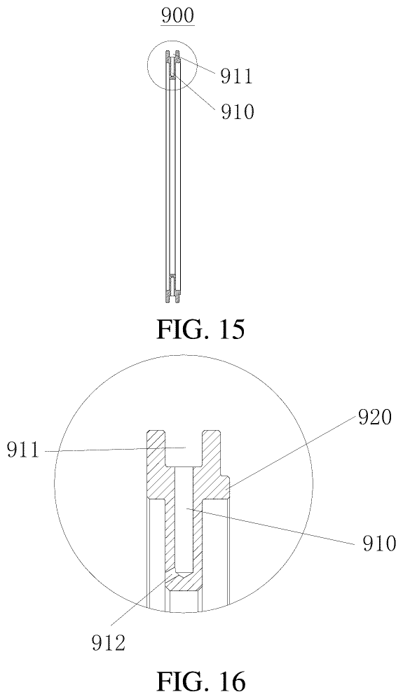

FIG. 14 is a front view of an oil distribution ring of the present disclosure; FIG. 15 is a cross-sectional view along a line B-B of FIG. 14; FIG. 16 is a partially enlarged view of FIG. 15. As shown in FIG. 14 to FIG. 16, the oil distribution block is, for example, an oil distribution ring 900. The oil distribution ring 900 is substantially annular, and includes an oil inlet ring belt 911, a plurality of oil distribution ring oil distribution channels 910, and a plurality of oil distribution ring oil spraying ports 912 successively arranged along a lubricating oil conveying direction. The oil inlet ring belt 911 is circumferentially arranged along a circumference of the oil distribution ring 900; one ends of the oil distribution ring oil distribution channels 910 are communicated with the oil inlet ring belts 911, and the other ends thereof are communicated with the oil distribution ring oil spraying ports 912. In addition, the oil distribution ring oil distribution channels 910 are arranged along radial directions of the oil distribution ring 900. The oil distribution ring oil spraying ports 912 are provided on a side surface of the oil distribution ring 900, and the plurality of oil distribution ring oil spraying ports 912 are preferably arranged in a ring shape. The specific positions of the oil distribution ring oil spraying ports 912 are not limited in the present disclosure and can be adjusted according to a region to be lubricated.

The lubricating oil in the oil distribution chamber of the oil distributor 100 may enter the lubrication pipeline 132 through the oil outlet 131, then be conveyed to the built-in oil passage, subsequently be conveyed to the oil inlet ring belts 911 of the oil distribution ring 900 along the built-in oil passage, and then passes through the oil distribution ring oil distribution channels 910 to be then sprayed from the oil distribution ring oil spraying ports 912.

For example, the oil distribution ring 900 may be disposed on one side of the region to be lubricated (for example, a planetary gear, a planetary bearing, and a rear bearing of a parallel bull gear), to provide lubricating oil to the region to be lubricated through the oil distribution ring oil spraying ports 912.

To enable the oil distribution ring 900 to be installed more accurately, a flange 920 may further be provided on the side surface of the oil distribution ring 900. By adjusting a specific structure of the flange 920, an installation position of the oil distribution ring 900 can be controlled, and the oil distribution ring 900 is prevented from being installed reversely.

The specific shapes and angles of the oil inlet ring belts 911, the plurality of oil distribution ring oil distribution channels 910, and the plurality of oil distribution ring oil spraying ports 912 are not limited in the present disclosure, and can be adjusted according to needs. Preferably, hole diameters of the oil distribution ring oil spraying ports 912 range from 0.5 mm to 10 mm. The oil distribution ring oil spraying ports 912 may be located on one side or two sides of the oil distribution ring 900.

The above-mentioned oil distribution block such as the oil distribution ring 900 or the oil distribution plate 800 can more accurately control the spraying positions of the lubricating oil. Compared with a conventional built-in oil passage, the oil distribution block is convenient to process, and the flexibility of the built-in oil passage is increased.

In summary, the present disclosure provides an oil distributor having both an oil outlet and an oil distribution pipe, so that the oil distributor can not only convey lubricating oil to different lubrication pipelines to provide the lubricating oil to a plurality of lubrication points, but also directly spray the lubricating oil to the lubrication points inside the reducer, to reduce the number of oil conveying pipelines inside the reducer and avoid the damage caused by a broken part to the gears when a welding portion of the oil conveying pipelines is broken. Therefore, the lubrication effect is good and the service life is long. In addition, the design of an oil distribution block such as an oil distribution ring or an oil distribution plate increases the flexibility of an built-in oil passage, and spraying positions of the lubricating oil can be controlled more accurately.

### LIST OF REFERENTIAL NUMERALS

100 oil distributor
110 top surface
111 oil inlet hole
120 bottom surface
121 oil spraying hole
130 side surface
131 oil outlet
132 lubrication pipeline
150 oil distribution pipe
151 limiting structure
200 reducer
210 housing
211 through hole
800 oil distribution plate
810 oil distribution plate oil distribution channel
811 oil distribution plate oil inlet
812 oil distribution plate oil spraying port
820 fixing hole
880 built-in oil passage
890 rear bearing
900 oil distribution ring
911 oil inlet ring belt
910 oil distribution ring oil distribution channel
912 oil distribution ring oil spraying port
920 flange

What is claimed is:

1. An oil distributor, comprising:
a top surface, wherein the top surface comprises an oil inlet hole, the oil inlet hole being communicated with an oil inlet pipeline in an external oil passage;
a bottom surface being opposite to the top surface, wherein the bottom surface is disposed at a through hole of a housing of a reducer and the bottom surface comprises an oil distribution pipe located inside the housing of the reducer, the oil distribution pipe including at least one oil spraying hole, and the oil spraying hole being communicated with an interior of the housing of the reducer; and
a side surface being located between the top surface and the bottom surface, wherein the side surface comprises at least one oil outlet, the oil outlet being communicated with a lubrication pipeline, and wherein the top surface, the bottom surface, and the side surface form an oil distribution chamber.

2. The oil distributor according to claim 1, wherein the oil distribution pipe further comprises a limiting structure at an end of the oil distribution pipe approaching the bottom surface.

3. The oil distributor according to claim 1, wherein an end of the oil distribution pipe away from the bottom surface is closed.

4. The oil distributor according to claim 1, wherein the lubrication pipeline is partially communicated with a built-in oil passage.

5. The oil distributor according to claim 1, wherein a sealing structure is between the oil distributor and the housing.

6. The oil distributor according to claim 1, wherein the through hole of the housing of the reducer is located above a side surface of a meshed portion of a gear pair in the reducer, and the oil distribution pipe is located above the meshed portion of the gear pair.

7. The oil distributor according to claim 1, wherein an oil spraying range of the oil spraying hole is between a first connection line and a second connection line, the first connection line being between a center of the oil distribution pipe and a center of a bull gear of a gear pair, and the second connection line being between the center of the oil distribution pipe and a center of a pinion of the gear pair.

8. The oil distributor according to claim 1, wherein a first end of a built-in oil passage of the reducer is communicated with the lubrication pipeline, and a second end of the built-in oil passage of the reducer comprises an oil distribution block.

9. The oil distributor according to claim 8, wherein:
the oil distribution block comprises an oil distribution plate, the oil distribution plate being T-shaped; and
an oil distribution channel of the oil distribution plate is disposed inside the oil distribution plate, one end of the oil distribution channel of the oil distribution plate being an oil inlet communicated of the oil distribution plate with the built-in oil passage, and the other end of the oil distribution channel of the oil distribution plate being at least one oil spraying port of the oil distribution plate leading to a region to be lubricated.

10. The oil distributor according to claim 8, wherein the oil distribution block is annular and further comprises an oil inlet ring belt, a plurality of oil distribution ring channels, and a plurality of oil spraying ring ports being successively arranged along a lubricating oil conveying direction.
